(19) United States
(12) Patent Application Publication
(10) Pub. No.: US 2026/0073317 A1
(43) Pub. Date: Mar. 12, 2026

(54) METHOD FOR EVALUATING PROJECT BASED ON LARGE MODEL, ELECTRONIC DEVICE AND STORAGE MEDIUM

(71) Applicant: Beijing Baidu Netcom Science Technology Co., Ltd., Beijing (CN)

(72) Inventor: Jinlong Chen, Beijing (CN)

(21) Appl. No.: 19/390,922

(22) Filed: Nov. 17, 2025

(30) Foreign Application Priority Data
Dec. 11, 2024 (CN) 202411824249.4

(51) Int. Cl. G06Q 10/063; G06Q 10/04; G06Q 10/10

(52) U.S. Cl. CPC G06Q 10/063; G06Q 10/04; G06Q 10/103

(57) ABSTRACT

Provided is a method apparatus for evaluating a project based on a large model, an electronic device, and a storage medium, relating to the field of computer technology, and in particular to fields of software and hardware project development, software and hardware project evaluation, machine learning, large model and other applications. The method includes: obtaining an evaluation intention for a target project; where the evaluation intention is used to request an evaluation of the target project under a specific evaluation indicator; obtaining an initial evaluation result for the target project under the specific evaluation indicator based on the evaluation intention using the large model; and obtaining a target evaluation result for the target project based on the initial evaluation result.

### CROSS-REFERENCE TO RELATED APPLICATIONS

The present application claims priority to Chinese Patent Application No. CN202411824249.4, filed with the China National Intellectual Property Administration on Dec. 11, 2024, the disclosure of which is hereby incorporated herein by reference in its entirety.

### TECHNICAL FIELD

The present disclosure relates to the field of computer technology, and in particular to fields of software and hardware project development, software and hardware project evaluation, machine learning, large model and other applications, and specifically to a method and an apparatus for evaluating a project based on a large model, and an electronic device.

### BACKGROUND

With the advancement of digitalization of the delivery process of projects (e.g., software and hardware projects), the project implementer hopes to conveniently master the progress of each stage in the software project delivery process and evaluates relevant indicators (e.g., project health, project risk, estimated completion time, project benefit, etc.) of subsequent stages, aiming at ensuring the high efficiency and controllability of overall delivery.

### SUMMARY

The present disclosure provides a method and an apparatus for evaluating a project based on a large model, and an electronic device.

According to a first aspect of the present disclosure, provided is a method for evaluating a project based on a large model, including:
obtaining an evaluation intention for a target project; where the evaluation intention is used to request an evaluation of the target project under a specific evaluation indicator;
obtaining an initial evaluation result for the target project under the specific evaluation indicator based on the evaluation intention using the large model; and
obtaining a target evaluation result for the target project based on the initial evaluation result.

According to a second aspect of the present disclosure, provided is an apparatus for evaluating a project based on a large model, including:
an intention obtaining unit configured to obtain an evaluation intention for a target project; where the evaluation intention is used to request an evaluation of the target project under a specific evaluation indicator;
a first result obtaining unit configured to obtain an initial evaluation result for the target project under the specific evaluation indicator based on the evaluation intention using the large model; and
a second result obtaining unit configured to obtain a target evaluation result for the target project based on the initial evaluation result.

According to a third aspect of the present disclosure, provided is an electronic device, including:
at least one processor;
a memory connected in communication with the at least one processor;
where the memory stores an instruction executable by the at least one processor, and the instruction, when executed by the at least one processor, enables the at least one processor to execute the method provided in the first aspect of the present disclosure.

According to a fourth aspect of the present disclosure, provided is a non-transitory computer-readable storage medium storing a computer instruction thereon, and the computer instruction is used to cause a computer to execute the method provided in the first aspect of the present disclosure.

According to a fifth aspect of the present disclosure, provided is a computer program product including a computer program, and the computer program implements the method provided in the first aspect of the present disclosure, when executed by a processor.

The use of the present disclosure can improve the efficiency and reliability in obtaining the target evaluation result for the target project.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flow chart of a method for evaluating a project based on a large model according to an embodiment of the present disclosure;

FIG. 2 is a schematic diagram of a workflow of a data search model according to an embodiment of the present disclosure;

FIG. 3 is a schematic diagram of a workflow of a data processing model according to an embodiment of the present disclosure;

FIG. 4 is a schematic diagram of a workflow of a predictive reasoning model according to an embodiment of the present disclosure;

FIG. 5 is a diagram illustrating a complete flow of a method for evaluating a project based on a large model according to an embodiment of the present disclosure;

FIG. 6 is a schematic diagram of an application scenario of a method for evaluating a project based on a large model according to an embodiment of the present disclosure;

FIG. 7 is a schematic structural block diagram of an apparatus for evaluating a project based on a large model according to an embodiment of the present disclosure; and

FIG. 8 is a schematic structural block diagram of an electronic device according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

As described in the background, with the advancement of digitalization of the project delivery process, the project implementer hopes to conveniently master the progress of each stage in the software project delivery process and evaluates relevant indicators of subsequent stages, aiming at ensuring the high efficiency and controllability of overall delivery. At present, the project evaluation method adopted is usually: manually collecting the project data related to a target project, and obtaining an evaluation result for the target project based on the project data through manual evaluation. However, the manual evaluation not only consumes a lot of manpower, but also reduces the efficiency and reliability in obtaining the evaluation result due to personnel experience, subjective bias, work commitment, etc., thereby having a negative impact on the high efficiency and controllability of overall delivery.

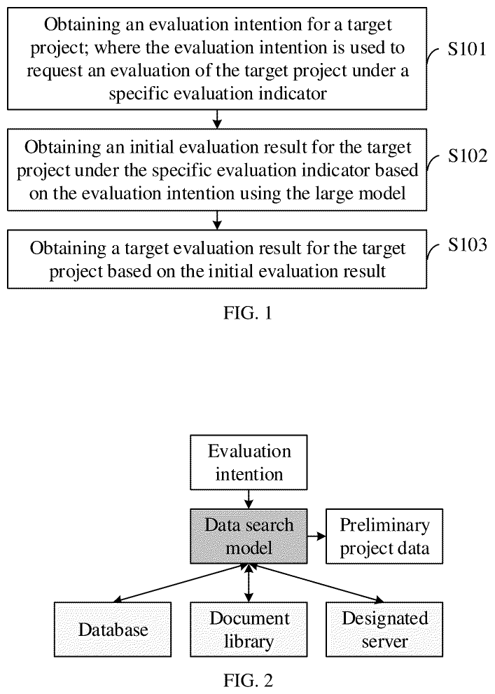

For the above problem, an embodiment of the present disclosure provide a method for evaluating a project based on a large model, which can be applied to an electronic device. Here, the electronic device may be a server or a terminal device, where the terminal device may be a workbench, a large-scale computer, a conventional computer (for example, a desktop computer, a notebook computer, a vehicle-mounted computer, etc.), a personal digital assistant, or any other similar computing device. Hereinafter, the method for evaluating the project based on the large model provided in the embodiment of the present disclosure will be described in combination with the schematic flow chart shown in FIG. 1. It should be noted that a logical sequence is shown in the schematic flowchart, but the steps shown or described in the flowchart may also be performed in other sequences in some cases.

Step S101: obtaining an evaluation intention for a target project.

Here, the target project may be a software or hardware project that is about to be developed or is being developed, such as a functional software development project, an application development project, a website development project, a system integration project, an infrastructure construction project, etc.; and the evaluation intention may be issued by a user (for example, a project member) to request the evaluation of the target project under a specific evaluation indicator. Here, the specific evaluation indicator may be project health, project risk, estimated completion time, project benefit, etc., which is not limited in the embodiment of the present disclosure. Exemplarily, the evaluation intention is: please evaluate the software project XX to obtain an evaluation result for the software project XX under the evaluation indicator “project benefit”, where the project benefit is the specific evaluation indicator.

Step S102: obtaining an initial evaluation result for the target project under the specific evaluation indicator based on the evaluation intention using the large model.

Here, the large model may be a large language model, where the large language model may be a pre-trained neural network model that has universal and reliable language knowledge, world knowledge, professional knowledge in various fields (for example, professional knowledge in the field of software and hardware project evaluation), etc. In one example, the large model may be an autoregressive generative model of Transformer architecture.

Since the large model has universal and reliable language knowledge, world knowledge and professional knowledge in various fields, the evaluation intention may be directly input into the large model after obtaining the evaluation intention for requesting the evaluation of the target project under the specific evaluation indicator, to obtain the initial evaluation result for the target project under the specific evaluation indicator based on the evaluation intention using the large model. For example, the specific evaluation indicator is project health, and then the initial evaluation result may include at least one of the project progress, budget control performance, degree of quality of resources, risk control capability and health score of the target project, or the overall health of the target project. For another example, the specific evaluation indicator is project benefit, and then the initial evaluation result may include at least one of the actual benefit, investment cost, or return on investment of the target project.

Step S103: obtaining a target evaluation result for the target project based on the initial evaluation result.

In the embodiment of the present disclosure, after the initial evaluation result is obtained, the initial evaluation result may be processed to obtain the target evaluation result for the target project. For example, the initial evaluation result may be processed according to a preset format requirement and/or a preset expression requirement to obtain the target evaluation result for the target project. Here, the preset format requirement and the preset expression requirement can be set according to actual service requirements or application scenarios, and are not limited in the embodiment of the present disclosure.

Using the method for evaluating the project based on the large model provided in the embodiment of the present disclosure, the evaluation intention for requesting the evaluation of the target project under specific evaluation indicator can be obtained, the initial evaluation result for the target project under the specific evaluation indicator can be obtained based on the evaluation intention using the large model, and then the target evaluation result for the target project can be obtained based on the initial evaluation result. On the one hand, the method for evaluating the project based on the large model provided in the embodiment of the present disclosure does not involve any substantial human participation, Therefore, compared with the prior art, this method can not only save human resources, but also eliminate the influence of subjective factors (for example, personnel experience, subjective bias, work involvement, etc.) on the target evaluation result, improving the efficiency and reliability in obtaining the target evaluation result. On the other hand, the main evaluation steps in the embodiment of the present disclosure are implemented based on the large model, and the large model has universal and reliable language knowledge, world knowledge and professional knowledge in various fields, thus further improving the reliability of the target evaluation result. Ultimately, the method for evaluating the project based on the large model provided in the embodiment of the present disclosure can have a positive impact on the high efficiency and controllability of overall delivery.

In some optional implementations, step S101, i.e., “obtaining an evaluation intention for a target project”, may include:
obtaining an initial intention for the target project;
generating inquiry information when determining that the initial intention has a clarity issue;
broadcasting the inquiry information; and
in response to an intention optimization request received after broadcasting the inquiry information, optimizing the initial intention to obtain the evaluation intention.

It can be understood that the initial intention may be used as the evaluation intention when determining that the initial intention has no clarity issue in the embodiment of the present disclosure.

Moreover, it should be noted that, in the embodiment of the present disclosure, when it is determined that the initial intention has a clarity issue, the inquiry information is generated and broadcast, and then the initial intention is optimized in response to the intention optimization request. After the optimized initial intention is obtained, if the optimized initial intention has no clarity issue, the optimized initial intention can be used as the evaluation intention; if the optimized initial intention has a clarity issue, the optimized initial intention is used as the new initial intention, and the steps of “using the initial intention as the evaluation intention when determining that the initial intention has no clarity issue; generating inquiry information when determining that the initial intention has a clarity issue; broadcasting the inquiry information; and optimizing the initial intention in response to the intention optimization request” are re-executed until the optimized initial intention has no clarity issue, and the optimized initial intention is used as the evaluation intention.

It should also be noted that step S101 may be performed using an intention recognition model in the embodiment of the present disclosure, where the intention recognition model may also be a large language model.

Specifically, in the embodiment of the present disclosure, the intention recognition model may be used to determine a plurality of preset word slots, so as to obtain a clarity evaluation result indicating that the initial intention has no clarity issue when there are a plurality of intention keywords in one-to-one correspondence to the plurality of preset word slots in the initial intention; otherwise, obtain a clarity evaluation result indicating that the initial intention has a clarity issue. Afterwards, when the clarity evaluation result indicates that the initial intention has no clarity issue, the initial intention may be used as the evaluation intention; when the clarity evaluation result indicates that the initial intention has a clarity issue, a word slot to be supplemented is determined, the inquiry information is generated based on the word slot to be supplemented, the inquiry information is then broadcast to prompt the user that an intention optimization request needs to be issued, and the initial intention is optimized in response to the intention optimization request after receiving the intention optimization request. Here, the word slot to be supplemented may be a preset word slot with an empty intention keyword captured from the initial intention; and the inquiry information may be broadcast by voice and/or displayed in text.

Exemplarily, the plurality of preset word slots include: [project name] and [specific evaluation indicator], and the initial intention is: please evaluate the software project XX to obtain an evaluation result for the software project XX under the evaluation indicator “project benefit”. Here, the intention keyword captured by the preset word slot [project name] is software project XX, and the intention keyword captured by the preset word slot [specific evaluation indicator] is project benefit, so the clarity evaluation result indicating that the initial intention has no clarity issue can be obtained, and the initial intention is used as the evaluation intention.

Exemplarily, the plurality of preset word slots include: [project name] and [specific evaluation indicator], and the initial intention is: please evaluate the software project XX to obtain an evaluation result for the software project XX. Here, the intention keyword captured by the preset word slot [project name] is software project XX, and the intention keyword captured by the preset word slot [specific evaluation indicator] is empty, so the clarity evaluation result indicating that the initial intention has a clarity issue can be obtained, and [specific evaluation indicator] is determined as the word slot to be supplemented. Afterwards, the inquiry information may be generated based on the word slot to be supplemented, and the inquiry information may be broadcast to prompt the user that an intention optimization request needs to be issued, and the initial intention may be optimized in response to the intention optimization request after receiving the intention optimization request. Assume there is inquiry information generated based on the word slot to be supplemented: under what evaluation indicator do you need to evaluate the software project XX? Here, the candidate evaluation indicators include project health, project risk, estimated completion time and project benefit. Then assume that the received intention optimization request is: please evaluate the software project XX under the evaluation indicator “project benefit”. Then the initial intention may be optimized in response to the intention optimization request after receiving the intention optimization request, to obtain an optimized initial intention: please evaluate the software project XX to obtain an evaluation result for the software project XX under the evaluation indicator “project benefit”. Here, the optimized initial intention has no clarity issue, so the optimized initial intention can be used as the evaluation intention.

Through the above method, in the embodiment of the present disclosure, the initial intention for the target project can be obtained, the inquiry information is generated when it is determined that the initial intention has a clarity issue, the inquiry information is broadcast, and then the initial intention is optimized to obtain the evaluation intention in response to the intention optimization request received after the inquiry information is broadcast, so that the clarity of the evaluation intention can be ensured, that is, the large model can clearly understand the evaluation intention, thereby further improving the reliability of the target evaluation result.

In some optional implementations, “obtaining an initial evaluation result for the target project under specific evaluation indicator based on the evaluation intention” in step S102 may include:
scheduling a data search model to use the data search model to obtain preliminary project data related to the target project and targeting the specific evaluation indicator based on the evaluation intention;
scheduling a data processing model to use the data processing model to optimize the preliminary project data based on the evaluation intention to obtain target project data; and
scheduling a predictive reasoning model to use the predictive reasoning model to process the target project data based on the evaluation intention to obtain the initial evaluation result for the target project under the specific evaluation indicator.

Here, the data search model, the data processing model and the predictive reasoning model may all be fine-tuned large language models; the preliminary project data may be the preliminarily selected project data generated and recorded during the current period, related to the target project and targeting the specific evaluation indicator; and correspondingly, the target project data may be the finally selected project data generated and recorded during the current period, related to the target project and targeting the specific evaluation indicator.

In one example, “obtaining preliminary project data related to the target project and targeting the specific evaluation indicator based on the evaluation intention” may include:
determining at least one target data source from a plurality of candidate data sources based on the evaluation intention;
obtaining original project data related to the target project and targeting the specific evaluation indicator from each of the at least one target data source, to obtain at least one original project data in one-to-one correspondence to the at least one target data source; and
obtaining the preliminary project data based on the at least one original project data.

Here, the plurality of candidate data sources may be databases, document libraries and designated servers related to a target organization (for example, a company responsible for developing the target project).

Referring to FIG. 2, in a specific example, after the evaluation intention for requesting the evaluation of the target project under the specific evaluation indicator is obtained, the data search model may be used to determine at least one candidate data source corresponding to the specific evaluation indicator from the plurality of candidate data sources (including databases, document libraries and designated servers) according to a built-in data source correspondence as the target data source to obtain at least one target data source. For example, when the specific evaluation indicator is project benefit, the candidate data sources corresponding to the specific evaluation indicator may include databases, document libraries and designated servers.

After at least one target data source is determined from the plurality of candidate data sources based on the evaluation intention, the data search model may be used to obtain the original project data related to the target project and targeting the specific evaluation indicator from each of the at least one target data source according to a built-in data search strategy, to obtain at least one original project data in one-to-one correspondence to the at least one target data source. For example, the specific evaluation indicator is project benefit, and then the original project data related to the target project and targeting the specific evaluation indicator obtained from a database according to the data search strategy may include the project contract, asset consumption status, etc. of the target project; the original project data related to the target project and targeting the specific evaluation indicator obtained from a document library may include professional terms of the target project, etc.; and the original project data related to the target project and targeting the specific evaluation indicator obtained from a designated server may include salaries, reimbursement expenses, etc. of project members.

After at least one original project data in one-to-one correspondence to the at least one target data source is obtained, the at least one original project data may be used together as the preliminary project data, that is, the at least one original project data may be merged to obtain the preliminary project data.

In the above example, the data search model can be used to determine at least one target data source from the plurality of candidate data sources based on the evaluation intention, and obtain the original project data related to the target project and targeting the specific evaluation indicator from each of the at least one target data source, to obtain at least one original project data in one-to-one correspondence to the at least one target data source and then obtain the preliminary project data based on the at least one original project data. In this process, there is also no substantial human involvement, thus further improving the efficiency and reliability in obtaining the target evaluation result; and the preliminary project data is obtained by using the data search model without involving complex calculation logic, thus also further improving the efficiency and reliability in obtaining the target evaluation result.

Moreover, as mentioned above, the data search model may be a fine-tuned large language model (hereinafter referred to as the first large language model for ease of distinction) in the embodiment of the present disclosure. The process of fine-tuning the first large language model will be described below:

(1) Obtaining a first evaluation intention sample for a first target project sample.

Here, the first target project sample may be a completed software and hardware project, such as a functional software development project, an application development project, a website development project, a system integration project, an infrastructure construction project, etc.; and the first evaluation intention sample may be used to request an evaluation of the first target project sample under a first specific evaluation indicator, where the first specific evaluation indicator may be project health, project risk, estimated completion time, project benefit, etc.

(2) Obtaining a preliminary project data sample related to the first target project sample and targeting the first specific evaluation indicator as a preliminary project data label based on the first evaluation intention sample through manual search.

In one example, at least one first target data source may be determined from a plurality of candidate data sources based on the first evaluation intention sample through manual search, and the preliminary project data sample related to the first target project sample and targeting the first specific evaluation indicator may be obtained from the at least one first target data source as the preliminary project data label.

(3) Obtaining a preliminary project data sample related to the first target project sample and targeting the first specific evaluation indicator as predictive preliminary project data based on the first evaluation intention sample using the first large language model.

It can be understood that, in the embodiment of the present disclosure, the first large language model can be used to determine at least one second target data source from a plurality of candidate data sources based on the first evaluation intention sample, obtain an original project data sample related to the first target project sample and targeting the first specific evaluation indicator from each of the at least one second target data source to obtain at least one original project data sample in one-to-one correspondence to the at least one second target data source, and then obtain the preliminary project data as the predictive preliminary project data based on the at least one original project data sample.

In one example, after the first evaluation intention sample for requesting the evaluation of the first target project sample under the first specific evaluation indicator is obtained, the first large language model may be used to determine at least one first candidate data source corresponding to the first specific evaluation indicator from a plurality of candidate data sources (including databases, document libraries and designated servers) according to a built-in data source correspondence as the second target data source to obtain at least one second target data source, and then the first large language model is used to obtain an original project data sample related to the first target project sample and targeting the first specific evaluation indicator from each of the at least one second target data source according to a built-in data search strategy, to obtain at least one original project data sample in one-to-one correspondence to the at least one second target data source, and obtain the preliminary project data as the predictive preliminary project data based on the at least one original project data sample.

(4) Calculating the first data loss of the predictive preliminary project data and the preliminary project data label.

When the first data loss meets the first loss requirement, the first large language model is used as the data search model; when the first data loss does not meet the first loss requirement, the first large language model is fine-tuned to obtain a fine-tuned first large language model, and the fine-tuned first large language model is used as the new first large language model, and the process of fine-tuning the first large language model is re-entered. Here, the first loss requirement can be set according to actual service requirements or application scenarios, and is not limited in the embodiment of the present disclosure.

It can be understood that fine-tuning the first large language model may affect at least one of the data source correspondence and the data search strategy in the embodiment of the present disclosure.

In one example, “optimizing the preliminary project data based on the evaluation intention to obtain target project data” may include:
optimizing the preliminary project data respectively from a plurality of optimization dimensions based on the evaluation intention to obtain the target project data.

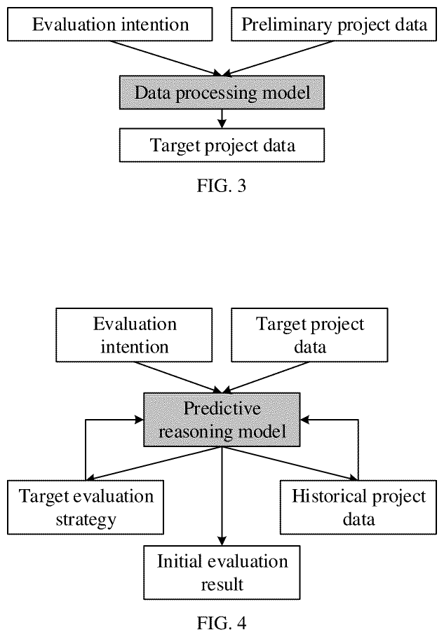

Referring to FIG. 3, in one specific example, the data processing model may be used to optimize the preliminary project data respectively from the plurality of optimization dimensions based on the evaluation intention according to a built-in data optimization strategy to obtain the target project data. Here, the plurality of optimization dimensions may include at least one of data deduplication, removal of redundant data, or merging of data with same attribute.

Here, the data deduplication may be deduplication performed on multiple pieces of project data with the same meaning. For example, there is a first piece of project data “Project member A's salary in May 2024 is thirty thousand yuan” and a second piece of project data “Project member A's salary in May 2024 is CNY 30,000” in the preliminary project data. Since the two pieces of project data have the same meaning, deduplication may be performed on the two pieces of project data. Specifically, only the first piece of project data or only the second piece of project data may be retained. The removal of redundant data may be removing redundant data from the preliminary project data, and the redundant data may be project data having no substantial relevance to the target project or having substantial relevance to the target project but not targeting the specific evaluation indicator determined by the data processing model. The merging of data with same attribute may be merging data with the same attribute. For example, there is a third piece of project data “Project member A's salary in June 2024 is CNY 30,000” and a fourth piece of project data “Project member A's project bonus in June 2024 is CNY 10,000” in the preliminary project data. Since the two pieces of project data have the same attribute, the two pieces of project data may be merged to obtain the new project data “Project member A's salary and project bonus in June 2024 is CNY 40,000 in total”.

In the above example, the data processing model can be used to optimize the preliminary project data respectively from the plurality of optimization dimensions based on the evaluation intention to obtain the target project data. In this process, there is also no substantial human involvement, thus further improving the efficiency and reliability in obtaining the target evaluation result; and the target project data is obtained by using the data processing model without involving complex calculation logic, thus also further improving the efficiency and reliability in obtaining the target evaluation result.

Moreover, as mentioned above, the data processing model may be a fine-tuned large language model (hereinafter referred to as the second large language model for ease of distinction) in the embodiment of the present disclosure. The process of fine-tuning the second large language model will be described below:

(1) Obtaining a second evaluation intention sample for a second target project sample, and a preliminary project data sample related to the second target project sample and targeting a second specific evaluation indicator.

Here, the second target project sample may be a completed software and hardware project, such as a functional software development project, an application development project, a website development project, a system integration project, an infrastructure construction project, etc.; and the second evaluation intention sample may be used to request an evaluation of the second target project sample under the second specific evaluation indicator, where the second specific evaluation indicator may be project health, project risk, estimated completion time, project benefit, etc.

(2) Optimizing the preliminary project data sample respectively from a plurality of optimization dimensions based on the second evaluation intention sample through manual processing, to obtain a target project data sample as a target project data label.

(3) Optimizing the preliminary project data sample respectively from a plurality of optimization dimensions based on the second evaluation intention sample using the second large language model, to obtain a target project data sample as predictive target project data.

It can be understood that, in the embodiment of the present disclosure, the second large language model can be used to optimize the preliminary project data sample respectively from the plurality of optimization dimensions based on the second evaluation intention sample according to the built-in data optimization strategy, to obtain the target project data sample as the predictive target project data.

(4) Calculating the second data loss of the predictive target project data and the target project data label.

When the second data loss meets the second loss requirement, the second large language model is used as the data processing model; when the second data loss does not meet the second loss requirement, the second large language model is fine-tuned to obtain a fine-tuned second large language model, and the fine-tuned second large language model is used as the new second large language model, and the process of fine-tuning the second large language model is re-entered. Here, the second loss requirement can be set according to actual service requirements or application scenarios, and is not limited in the embodiment of the present disclosure.

It can be understood that fine-tuning the second large language model can affect the data optimization strategy in the embodiment of the present disclosure.

In one example, “processing the target project data based on the evaluation intention to obtain the initial evaluation result for the target project under the specific evaluation indicator” may include:
obtaining a target evaluation strategy based on the evaluation intention;
obtaining historical project data related to the target project and targeting the specific evaluation indicator; and
processing the target project data and the historical project data according to the target evaluation strategy to obtain the initial evaluation result for the target project under the specific evaluation indicator.

Here, the historical project data may be the finally selected project data generated and recorded during a historical period, related to the target project and targeting the specific evaluation indicator, where the historical period is another period that is continuous with and located before the current period.

Referring to FIG. 4, in a specific example, after the evaluation intention for requesting the evaluation of the target project under the specific evaluation indicator is obtained, the predictive reasoning model may be used to select a target evaluation strategy corresponding to the specific evaluation indicator from a plurality of candidate evaluation strategies according to a built-in evaluation strategy correspondence, obtain the historical project data related to the target project and targeting the specific evaluation indicator, and then process the target project data and the historical project data according to the target evaluation strategy to obtain the initial evaluation result for the target project under the specific evaluation indicator.

Specifically, when the historical project data related to the target project and targeting the specific evaluation indicator is obtained, the data search model may be scheduled again to use the data search model to obtain the preliminary historical project data related to the target project and targeting the specific evaluation indicator based on the evaluation intention, and the data processing model may be scheduled again to use the data processing model to optimize the preliminary historical project data based on the evaluation intention to obtain the historical project data that is finally selected. The specific process may refer to the above related description of “scheduling the data search model to use the data search model to obtain the preliminary project data related to the target project and targeting the specific evaluation indicator based on the evaluation intention; and scheduling the data processing model to use the data processing model to optimize the preliminary project data based on the evaluation intention to obtain the target project data”, which will not be repeated here.

In another specific example, “processing the target project data and the historical project data according to the target evaluation strategy to obtain the initial evaluation result for the target project under the specific evaluation indicator” may include:
predicting subsequent project data related to the target project and targeting the specific evaluation indicator based on the target project data and the historical project data; and
obtaining the initial evaluation result for the target project under the specific evaluation indicator based on the target project data, the historical project data and the subsequent project data according to the target evaluation strategy.

Here, the subsequent project data may be project data related to the target project and targeting the specific evaluation indicator that may be generated and recorded in a future period, where the future period is another period that is continuous with and located after the current period.

Moreover, it should be noted that, in the embodiment of the present disclosure, after the target project data and the historical project data are obtained, the predictive reasoning model can be used to predict the subsequent project data related to the target project and targeting the specific evaluation indicator based on the target project data and the historical project data according to a built-in data prediction algorithm. Here, the data prediction algorithm may be time series analysis method, regression analysis method, etc. After the target project data, the historical project data and the subsequent project data are obtained, the predictive reasoning model can be used to obtain the initial evaluation result for the target project under the specific evaluation indicator based on the target project data, the historical project data and the subsequent project data according to the target evaluation strategy.

In the above example, the predictive reasoning model can be used to obtain the target evaluation strategy based on the evaluation intention, obtain the historical project data related to the target project and targeting the specific evaluation indicator, and then process the target project data and the historical project data according to the target evaluation strategy to obtain the initial evaluation result for the target project under the specific evaluation indicator. Specifically, the subsequent project data related to the target project and targeting the specific evaluation indicator may be predicted based on the target project data and the historical project data, and the initial evaluation result for the target project under the specific evaluation indicator may be obtained based on the target project data, the historical project data and the subsequent project data according to the target evaluation strategy. In this process, there is also no substantial human involvement, thus further improving the efficiency and reliability in obtaining the target evaluation result; and the initial evaluation result is obtained by using the predictive reasoning model without involving complex calculation logic, thus also further improving the efficiency and reliability in obtaining the target evaluation result.

Moreover, as mentioned above, the predictive reasoning model may be a fine-tuned large language model (hereinafter referred to as the third large language model for ease of distinction) in the embodiment of the present disclosure. The process of fine-tuning the third large language model will be described below:

(1) Obtaining a third evaluation intention sample for a third target project sample, and a target project data sample related to the third target project sample and targeting a third specific evaluation indicator.

Here, the third target project sample may be a completed software and hardware project, such as a functional software development project, an application development project, a website development project, a system integration project, an infrastructure construction project, etc.; and the third evaluation intention sample may be used to request an evaluation of the third target project sample under the third specific evaluation indicator, where the third specific evaluation indicator may be project health, project risk, estimated completion time, project benefit, etc.

(2) Processing the target project data sample based on the third evaluation intention sample through manual evaluation, to obtain a true evaluation result for the third target project sample under the third specific evaluation indicator as an evaluation result label.

In one example, the data search model may be scheduled to use the data search model to obtain a preliminary historical project data sample related to the third target project sample and targeting the third specific evaluation indicator based on the third evaluation intention sample, and the data processing model may be scheduled to use the data processing model to optimize the preliminary historical project data sample based on the third evaluation intention sample to obtain a historical project data sample that is finally selected. The specific process may refer to the above related description of “scheduling the data search model to use the data search model to obtain the preliminary project data related to the target project and targeting the specific evaluation indicator based on the evaluation intention; and scheduling the data processing model to use the data processing model to optimize the preliminary project data based on the evaluation intention to obtain the target project data”, which will not be repeated here.

Moreover, since the third target project sample is a completed software and hardware project, the data search model may also be scheduled to use the data search model to obtain a preliminary subsequent project data sample related to the third target project sample and targeting the third specific evaluation indicator based on the third evaluation intention sample, and the data processing model may be scheduled to use the data processing model to optimize the preliminary subsequent project data sample based on the third evaluation intention sample to obtain a subsequent project data sample that is finally selected. The specific process may refer to the above related description of “scheduling the data search model to use the data search model to obtain the preliminary project data related to the target project and targeting the specific evaluation indicator based on the evaluation intention; and scheduling the data processing model to use the data processing model to optimize the preliminary project data based on the evaluation intention to obtain the target project data”, which will not be repeated here.

Thereafter, the true evaluation result for the third target project sample under the third specific evaluation indicator can be obtained as the evaluation result label based on the target project data sample, the historical project data sample and the subsequent project data sample through manual evaluation.

(3) Using the third large language model to process the target project data sample based on the third evaluation intention sample to obtain a predictive initial evaluation result for the third target project sample under the third specific evaluation indicator.

It can be understood that, in the embodiment of the present disclosure, the target evaluation strategy sample can be obtained based on the third evaluation intention sample, the historical project data sample related to the third target project sample and targeting the third specific evaluation indicator can be obtained, and then the target project data sample and the historical project data sample can be processed according to the target evaluation strategy sample, to obtain an initial evaluation result for the third target project sample under the third specific evaluation indicator as the predictive evaluation result.

In a specific example, after the third evaluation intention sample for requesting the evaluation of the third target project sample under the third specific evaluation indicator is obtained, the third large language model can be used to select a target evaluation strategy sample corresponding to the third specific evaluation indicator from a plurality of candidate evaluation strategies according to a built-in evaluation strategy correspondence, obtain a historical project data sample related to the third target project sample and targeting the third specific evaluation indicator, and then process the target project data sample and the historical project data sample according to the target evaluation strategy sample, to obtain the initial evaluation result for the third target project sample under the third specific evaluation indicator as the predictive evaluation result. Specifically, after the target project data sample and the historical project data sample are obtained, the third large language model can be used to predict a subsequent project data sample related to the third target project sample and targeting the third specific evaluation indicator based on the target project data sample and the historical project data sample according to a built-in data prediction algorithm. Here, the data prediction algorithm may be time series analysis method, regression analysis method, etc. After the target project data sample, historical project data sample and subsequent project data sample are obtained, the third large language model can be used to obtain the initial evaluation result for the third target project sample under the third specific evaluation indicator as the predictive evaluation result based on the target project data sample, historical project data sample and subsequent project data sample according to the target evaluation strategy sample.

(4) Calculating the third data loss of the predictive evaluation result and the evaluation result label.

When the third data loss meets the third loss requirement, the third large language model is used as the predictive reasoning model; when the third data loss does not meet the third loss requirement, the third large language model is fine-tuned to obtain a fine-tuned third large language model, and the fine-tuned third large language model is used as the new third large language model, and the process of fine-tuning the third large language model is re-entered. Here, the third loss requirement can be set according to actual service requirements or application scenarios, and is not limited in the embodiment of the present disclosure.

It can be understood that fine-tuning the third large language model may affect at least one of the evaluation strategy correspondence, the candidate evaluation strategies or the data prediction algorithm in the embodiment of the present disclosure.

Through the above method, in the embodiment of the present disclosure, the data search model can be scheduled to use the data search model to obtain the preliminary project data related to the target project and targeting the specific evaluation indicator based on the evaluation intention, the data processing model can be scheduled to use the data processing model to optimize the preliminary project data based on the evaluation intention to obtain the target project data, and then the predictive reasoning model can be scheduled to use the predictive reasoning model to process the target project data based on the evaluation intention to obtain the initial evaluation result for the target project under the specific evaluation indicator. On the one hand, in the embodiment of the present disclosure, three serially set models (data search model, data processing model and predictive reasoning model) are used to obtain the initial evaluation result for the target project under the specific evaluation indicator based on the evaluation intention, so the three models can be fine-tuned, tested and optimized independently, thereby increasing the flexibility and scalability of the project evaluation method; on the other hand, these three serially set models can perform preliminary selection, optimization and fusion on data respectively, thereby further improving the reliability of the target evaluation result.

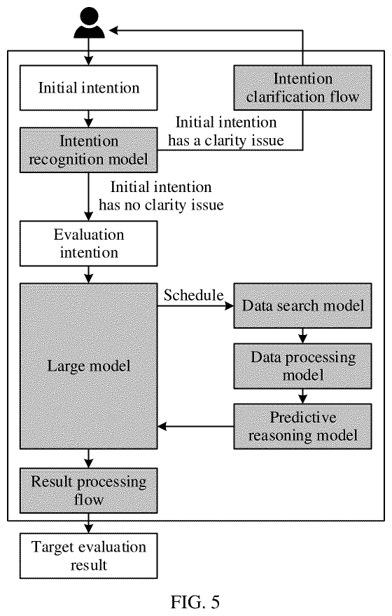

The complete flow of the method for evaluating the project based on the large model provided in the embodiment of the present disclosure will be described below in combination with FIG. 5.

Firstly, an initial intention sent from a user may be received.

After receiving the initial intention sent by the user, the intention recognition model may be used to identify the initial intention to determine whether the initial intention has a clarity issue, use the initial intention as the evaluation intention when determining that the initial intention has no clarity issue, and enter the intention clarification flow when determining that the initial intention has a clarity issue, that is, generate inquiry information, broadcast the inquiry information, and then optimize the initial intention in response to the intention optimization request. After the optimized initial intention is obtained, if the optimized initial intention has no clarity issue, the optimized initial intention can be used as the evaluation intention; if the optimized initial intention has a clarity issue, the optimized initial intention is used as the new initial intention, and the steps of “using the initial intention as the evaluation intention when determining that the initial intention has no clarity issue; generating inquiry information when determining that the initial intention has a clarity issue; broadcasting the inquiry information; and optimizing the initial intention in response to the intention optimization request” are re-executed until the optimized initial intention has no clarity issue, and the optimized initial intention is used as the evaluation intention. Here, the intention recognition model may be a large language model.

Then, the large model may be used to obtain the initial evaluation result for the target project under the specific evaluation indicator based on the evaluation intention. Here, the large model may be a large language model. Specifically, the large model may be used to:
schedule a data search model to use the data search model to obtain preliminary project data related to the target project and targeting the specific evaluation indicator based on the evaluation intention;
schedule a data processing model to use the data processing model to optimize the preliminary project data based on the evaluation intention to obtain target project data; and
schedule a predictive reasoning model to use the predictive reasoning model to process the target project data based on the evaluation intention to obtain the initial evaluation result for the target project under the specific evaluation indicator.

Finally, the result processing flow may be entered, that is, the initial evaluation result is processed to obtain the target evaluation result for the target project. For example, the initial evaluation result may be processed according to a preset format requirement and/or a preset expression requirement to obtain the target evaluation result for the target project. Here, the preset format requirement and the preset expression requirement can be set according to actual service requirements or application scenarios, and are not limited in the embodiment of the present disclosure.

The specific functions and examples of the above steps can refer to the relevant description of the corresponding steps in the above-mentioned embodiments of the method for evaluating the project based on the large model, and will not be repeated here.

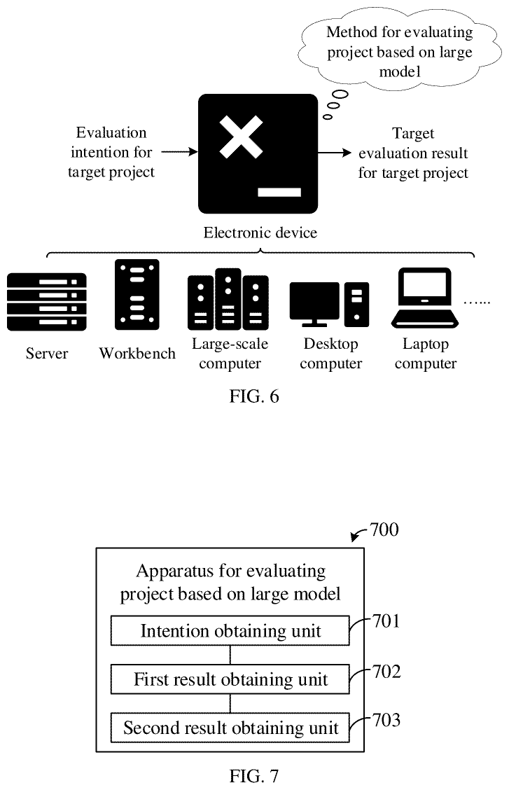

Referring to FIG. 6, it is a schematic diagram of an application scenario of a method for evaluating a project based on a large model according to an embodiment of the present disclosure.

The method for evaluating the project based on the large model provided in the embodiment of the present disclosure is applied to an electronic device. Here, the electronic device may be a server or a terminal device, where the terminal device may be a workbench, a large-scale computer, a conventional computer (for example, a desktop computer, a notebook computer, a vehicle-mounted computer, etc.), a personal digital assistant, or any other similar computing device.

Here, the electronic device is configured to:
obtain an evaluation intention for a target project; where the evaluation intention is used to request an evaluation of the target project under a specific evaluation indicator;
obtain an initial evaluation result for the target project under the specific evaluation indicator based on the evaluation intention using the large model; and
obtain a target evaluation result for the target project based on the initial evaluation result.

It should be noted that the schematic diagram of the application scenario shown in FIG. 6 is only illustrative and not restrictive in the embodiment of the present disclosure, those skilled in the art can make various obvious changes and/or replacements based on the example of FIG. 6, and the obtained technical solutions still belong to the disclosure scope of the embodiments of the present disclosure.

In order to better implement the above-mentioned method for evaluating the project based on the large model, an embodiment of the present disclosure further provides an apparatus for evaluating a project based on a large model, which can be integrated into an electronic device. Here, the electronic device may be a server or a terminal device, where the terminal device may be a workbench, a large-scale computer, a conventional computer (for example, a desktop computer, a notebook computer, a vehicle-mounted computer, etc.), a personal digital assistant, or any other similar computing device. Hereinafter, an apparatus 700 for evaluating a project based on a large model according to an embodiment of the present disclosure will be described in combination with the schematic structural block diagram shown in FIG. 7.

The apparatus 700 for evaluating the project based on the large model includes:
an intention obtaining unit 701 configured to obtain an evaluation intention for a target project; where the evaluation intention is used to request an evaluation of the target project under a specific evaluation indicator;
a first result obtaining unit 702 configured to obtain an initial evaluation result for the target project under the specific evaluation indicator based on the evaluation intention using the large model; and
a second result obtaining unit 703 configured to obtain a target evaluation result for the target project based on the initial evaluation result.

In some optional implementations, the first result obtaining unit 702 is configured to:
schedule a data search model to use the data search model to obtain preliminary project data related to the target project and targeting the specific evaluation indicator based on the evaluation intention;
schedule a data processing model to use the data processing model to optimize the preliminary project data based on the evaluation intention to obtain target project data; and
schedule a predictive reasoning model to use the predictive reasoning model to process the target project data based on the evaluation intention to obtain the initial evaluation result for the target project under the specific evaluation indicator.

In some optional implementations, the first result obtaining unit 702 is configured to:
determine at least one target data source from a plurality of candidate data sources based on the evaluation intention;
obtain original project data related to the target project and targeting the specific evaluation indicator from each of the at least one target data source, to obtain at least one original project data in one-to-one correspondence to the at least one target data source; and
obtain the preliminary project data based on the at least one original project data.

In some optional implementations, the first result obtaining unit 702 is configured to:
optimize the preliminary project data respectively from a plurality of optimization dimensions based on the evaluation intention to obtain the target project data; where the plurality of optimization dimensions include at least one of data deduplication, removal of redundant data, or merging of data with same attribute.

In some optional implementations, the first result obtaining unit 702 is configured to:
obtain a target evaluation strategy based on the evaluation intention;
obtain historical project data related to the target project and targeting the specific evaluation indicator; and
process the target project data and the historical project data according to the target evaluation strategy to obtain the initial evaluation result for the target project under the specific evaluation indicator.

In some optional implementations, the first result obtaining unit 702 is configured to:
predict subsequent project data related to the target project and targeting the specific evaluation indicator based on the target project data and the historical project data; and
obtain the initial evaluation result for the target project under the specific evaluation indicator based on the target project data, the historical project data and the subsequent project data according to the target evaluation strategy.

In some optional implementations, the second result obtaining unit 703 is configured to:
obtain an initial intention for the target project;
generate inquiry information when determining that the initial intention has a clarity issue;
broadcast the inquiry information; and
in response to an intention optimization request received after broadcasting the inquiry information, optimize the initial intention to obtain the evaluation intention.

In the embodiment of the present disclosure, the specific functions and examples of the units in the apparatus 700 for evaluating the project based on the large model can refer to the relevant description of the corresponding steps in the above-mentioned embodiments of the method for evaluating the project based on the large model, and will not be repeated here.

In the technical solution of the present disclosure, the acquisition, storage and application of the user's personal information involved are in compliance with relevant laws and regulations, and do not violate public order and good customs.

According to the embodiments of the present disclosure, the present disclosure further provides an electronic device, a readable storage medium and a computer program product.

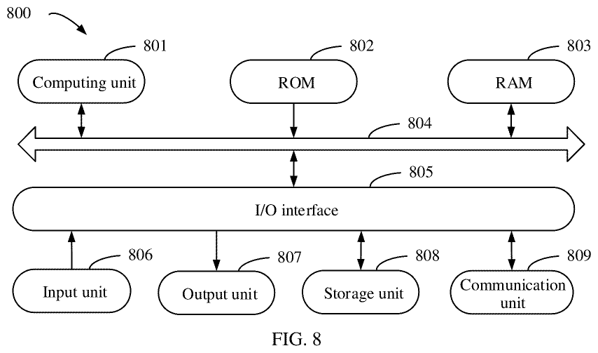

FIG. 8 shows a schematic structural block diagram of an exemplary electronic device 800 that may be used to implement the embodiments of the present disclosure. The electronic device is intended to represent various forms of digital computers, such as a vehicle-mounted computing device, a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 8, the electronic device 800 includes a computing unit 801 that may perform various appropriate actions and processes according to a computer program stored in a Read-Only Memory (ROM) 802 or a computer program loaded from a storage unit 808 into a Random Access Memory (RAM) 803. Various programs and data required for the operations of the electronic device 800 may also be stored in the RAM 803. The computing unit 801, the ROM 802 and the RAM 803 are connected to each other through a bus 804. The Input/Output (I/O) interface 805 is also connected to the bus 804.

A plurality of components in the electronic device 800 are connected to the I/O interface 805, and include: an input unit 806 such as a keyboard, a mouse, or the like; an output unit 807 such as various types of renderers, speakers, or the like; a storage unit 808 such as a magnetic disk, an optical disk, or the like; and a communication unit 809 such as a network card, a modem, a wireless communication transceiver, or the like. The communication unit 809 allows the electronic device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 801 performs various methods and processes described above, such as the method for evaluating the project based on the large model. For example, in some implementations, the method for evaluating the project based on the large model may be implemented as a computer software program tangibly contained in a computer-readable medium, such as the storage unit 808. In some implementations, a part or all of the computer program may be loaded and/or installed on the electronic device 800 via the ROM 802 and/or the communication unit 809. When the computer program is loaded into the RAM 803 and executed by the computing unit 801, one or more steps of the method for evaluating the project based on the large model described above may be performed. Alternatively, in other implementations, the computing unit 801 may be configured to perform the method for evaluating the project based on the large model by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System On Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, an RAM, an ROM, an Erasable Programmable Read-Only Memory (EPROM) or a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a rendering device (e.g., a Cathode Ray Tube (CRT) renderer or a Liquid Crystal Display (LCD)) for rendering information to the user; and a keyboard and a pointing device (e.g., a mouse or a trackball) through which the user may provide input to the computer. Other types of devices are also used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

An embodiment of the present disclosure further provides a non-transitory computer-readable storage medium storing a computer instruction thereon, and the computer instruction is used to cause a computer to execute the method for evaluating the project based on the large model.

An embodiment of the present disclosure further provides a computer program product including a computer program, and the computer program implements the method for evaluating the project based on the large model, when executed by a processor.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein. Moreover, the relational terms such as “first”, “second”, “third”, etc. in this disclosure are only used to distinguish one entity or operation from another entity or operation, and do not necessarily require or imply any such actual relationship or sequence between these entities or operations. Furthermore, “a plurality of” in the present disclosure can be understood as at least two.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for evaluating a project based on a large model, comprising:
obtaining an evaluation intention for a target project; wherein the evaluation intention is used to request an evaluation of the target project under a specific evaluation indicator;
obtaining, based on the evaluation intention, an initial evaluation result for the target project under the specific evaluation indicator, by using the large model; and
obtaining a target evaluation result for the target project, based on the initial evaluation result.

2. The method of claim 1, wherein the obtaining of the initial evaluation result for the target project under the specific evaluation indicator, based on the evaluation intention, comprises:
scheduling a data search model, to use the data search model to obtain preliminary project data related to the target project and targeting the specific evaluation indicator based on the evaluation intention;
scheduling a data processing model, to use the data processing model to optimize the preliminary project data based on the evaluation intention to obtain target project data; and
scheduling a predictive reasoning model, to use the predictive reasoning model to process the target project data based on the evaluation intention to obtain the initial evaluation result for the target project under the specific evaluation indicator.

3. The method of claim 2, wherein the obtaining of the preliminary project data related to the target project and targeting the specific evaluation indicator, based on the evaluation intention, comprises:
determining at least one target data source from a plurality of candidate data sources based on the evaluation intention;
obtaining original project data related to the target project and targeting the specific evaluation indicator from each of the at least one target data source, to obtain at least one original project data in one-to-one correspondence to the at least one target data source; and
obtaining the preliminary project data based on the at least one original project data.

4. The method of claim 2, wherein the optimizing of the preliminary project data based on the evaluation intention, to obtain the target project data, comprises:
optimizing the preliminary project data respectively from a plurality of optimization dimensions based on the evaluation intention, to obtain the target project data; wherein the plurality of optimization dimensions comprise at least one of data deduplication, removal of redundant data, or merging of data with same attribute.

5. The method of claim 2, wherein the processing of the target project data based on the evaluation intention, to obtain the initial evaluation result for the target project under the specific evaluation indicator, comprises:
obtaining a target evaluation strategy based on the evaluation intention;
obtaining historical project data related to the target project and targeting the specific evaluation indicator; and
processing the target project data and the historical project data according to the target evaluation strategy, to obtain the initial evaluation result for the target project under the specific evaluation indicator.

6. The method of claim 5, wherein the processing of the target project data and the historical project data according to the target evaluation strategy, to obtain the initial evaluation result for the target project under the specific evaluation indicator, comprises:
predicting subsequent project data related to the target project and targeting the specific evaluation indicator based on the target project data and the historical project data; and
obtaining the initial evaluation result for the target project under the specific evaluation indicator based on the target project data, the historical project data and the subsequent project data according to the target evaluation strategy.

7. The method of claim 1, wherein the obtaining of the evaluation intention for the target project, comprises:
obtaining an initial intention for the target project;
generating inquiry information, in a case where it is determined that the initial intention has a clarity issue;
broadcasting the inquiry information; and
in response to an intention optimization request received after broadcasting the inquiry information, optimizing the initial intention to obtain the evaluation intention.

8. An electronic device, comprising:
at least one processor;
a memory connected in communication with the at least one processor;
wherein the memory stores an instruction executable by the at least one processor, and the instruction, when executed by the at least one processor, enables the at least one processor to execute:
obtaining an evaluation intention for a target project; wherein the evaluation intention is used to request an evaluation of the target project under a specific evaluation indicator;
obtaining, based on the evaluation intention, an initial evaluation result for the target project under the specific evaluation indicator, by using a large model; and
obtaining a target evaluation result for the target project, based on the initial evaluation result.

9. The electronic device of claim 8, wherein the instruction, when executed by the at least one processor, enables the at least one processor to execute the obtaining of the initial evaluation result for the target project under the specific evaluation indicator, by:
scheduling a data search model, to use the data search model to obtain preliminary project data related to the target project and targeting the specific evaluation indicator based on the evaluation intention;
scheduling a data processing model, to use the data processing model to optimize the preliminary project data based on the evaluation intention to obtain target project data; and
scheduling a predictive reasoning model, to use the predictive reasoning model to process the target project data based on the evaluation intention to obtain the initial evaluation result for the target project under the specific evaluation indicator.

10. The electronic device of claim 9, wherein the instruction, when executed by the at least one processor, enables the at least one processor to execute the obtaining of the preliminary project data related to the target project and targeting the specific evaluation indicator, by:
determining at least one target data source from a plurality of candidate data sources based on the evaluation intention;
obtaining original project data related to the target project and targeting the specific evaluation indicator from each of the at least one target data source, to obtain at least one original project data in one-to-one correspondence to the at least one target data source; and
obtaining the preliminary project data based on the at least one original project data.

11. The electronic device of claim 9, wherein the instruction, when executed by the at least one processor, enables the at least one processor to execute the optimizing of the preliminary project data, by:
optimizing the preliminary project data respectively from a plurality of optimization dimensions based on the evaluation intention, to obtain the target project data; wherein the plurality of optimization dimensions comprise at least one of data deduplication, removal of redundant data, or merging of data with same attribute.

12. The electronic device of claim 9, wherein the instruction, when executed by the at least one processor, enables the at least one processor to execute the processing of the target project data, by:
obtaining a target evaluation strategy based on the evaluation intention;
obtaining historical project data related to the target project and targeting the specific evaluation indicator; and
processing the target project data and the historical project data according to the target evaluation strategy, to obtain the initial evaluation result for the target project under the specific evaluation indicator.

13. The electronic device of claim 12, wherein the instruction, when executed by the at least one processor, enables the at least one processor to execute the processing of the target project data and the historical project data, by:
predicting subsequent project data related to the target project and targeting the specific evaluation indicator based on the target project data and the historical project data; and
obtaining the initial evaluation result for the target project under the specific evaluation indicator based on the target project data, the historical project data and the subsequent project data according to the target evaluation strategy.

14. The electronic device of claim 8, wherein the instruction, when executed by the at least one processor, enables the at least one processor to execute the obtaining of the evaluation intention for the target project, by:
obtaining an initial intention for the target project;
generating inquiry information, in a case where it is determined that the initial intention has a clarity issue;
broadcasting the inquiry information; and
in response to an intention optimization request received after broadcasting the inquiry information, optimizing the initial intention to obtain the evaluation intention.

15. A non-transitory computer-readable storage medium storing a computer instruction thereon, wherein the computer instruction is used to cause a computer to execute:
obtaining an evaluation intention for a target project; wherein the evaluation intention is used to request an evaluation of the target project under a specific evaluation indicator;
obtaining, based on the evaluation intention, an initial evaluation result for the target project under the specific evaluation indicator, by using a large model; and
obtaining a target evaluation result for the target project, based on the initial evaluation result.

16. The non-transitory computer-readable storage medium of claim 15, wherein the computer instruction is used to cause the computer to execute the obtaining of the initial evaluation result for the target project under the specific evaluation indicator, by:
scheduling a data search model, to use the data search model to obtain preliminary project data related to the target project and targeting the specific evaluation indicator based on the evaluation intention;
scheduling a data processing model, to use the data processing model to optimize the preliminary project data based on the evaluation intention to obtain target project data; and
scheduling a predictive reasoning model, to use the predictive reasoning model to process the target project data based on the evaluation intention to obtain the initial evaluation result for the target project under the specific evaluation indicator.

17. The non-transitory computer-readable storage medium of claim 16, wherein the computer instruction is used to cause the computer to execute the obtaining of the preliminary project data related to the target project and targeting the specific evaluation indicator, by:
determining at least one target data source from a plurality of candidate data sources based on the evaluation intention;
obtaining original project data related to the target project and targeting the specific evaluation indicator from each of the at least one target data source, to obtain at least one original project data in one-to-one correspondence to the at least one target data source; and
obtaining the preliminary project data based on the at least one original project data.

18. The non-transitory computer-readable storage medium of claim 16, wherein the computer instruction is used to cause the computer to execute the optimizing of the preliminary project data, by:
optimizing the preliminary project data respectively from a plurality of optimization dimensions based on the evaluation intention, to obtain the target project data; wherein the plurality of optimization dimensions comprise at least one of data deduplication, removal of redundant data, or merging of data with same attribute.

19. The non-transitory computer-readable storage medium of claim 16, wherein the computer instruction is used to cause the computer to execute the processing of the target project data, by:
obtaining a target evaluation strategy based on the evaluation intention;
obtaining historical project data related to the target project and targeting the specific evaluation indicator; and
processing the target project data and the historical project data according to the target evaluation strategy, to obtain the initial evaluation result for the target project under the specific evaluation indicator.

20. The non-transitory computer-readable storage medium of claim 19, wherein the computer instruction is used to cause the computer to execute the processing of the target project data and the historical project data, by:
predicting subsequent project data related to the target project and targeting the specific evaluation indicator based on the target project data and the historical project data; and
obtaining the initial evaluation result for the target project under the specific evaluation indicator based on the target project data, the historical project data and the subsequent project data according to the target evaluation strategy.
